(19) United States
(12) Patent Application Publication
(10) Pub. No.: US 2026/0155491 A1
(43) Pub. Date: Jun. 4, 2026

(54) Insulation Member

(71) Applicant: LG Chem, Ltd., Seoul (KR)

(72) Inventors: Taegyeong Kang, Seoul (KR); Kyoungshil Oh, Seoul (KR); Myungeun Oh, Seoul (KR)

(73) Assignee: LG Chem, Ltd., Seoul (KR)

(21) Appl. No.: 19/405,757

(22) Filed: Dec. 2, 2025

(30) Foreign Application Priority Data
Dec. 4, 2024 (KR) 10-2024-0178813

(51) Int. Cl. H01M 10/658; H01M 10/651

(52) U.S. Cl. CPC H01M 10/658; H01M 10/651

(57) ABSTRACT

An insulation member may include a silica insulation composite having excellent heat resistance. The silica insulation composite may include a substrate and a silica network structure, the silica network structure including a plurality of silica particles and one or more pores. A film may wrap the silica insulation composite. Even when sealed with a film, the insulation member may have minimized degradation in heat blocking performance.

### CROSS-REFERENCE TO RELATED APPLICATION

This application claims priority under 35 U.S.C. § 119 to Korean Patent Application No. 10-2024-0178813 filed on Dec. 4, 2024, the content of which is incorporated by reference in its entirety.

### TECHNICAL FIELD

The present disclosure relates to an insulation member.

### BACKGROUND

A silica insulation sheet comprising a fiber and a silica network structure is widely used as a functional insulation material in construction or industrial fields, and in particular, has recently been also applied as an insulation material for batteries in electric vehicles, and the like.

A battery used in an electric vehicle and the like is a high-output large-capacity battery, and a large amount of heat is generated during charging and discharging processes. If the heat generated as described above is not effectively removed, the possibility of ignition or explosion increases due to heat accumulation. Therefore, in order to prevent thermal runaway of the battery, a silica insulation sheet may be interposed between cells of the battery to achieve a heat blocking effect.

However, if the silica insulation sheet is applied to the battery, it is required to encapsulate the entire surface of the silica insulation sheet with a film to prevent silica particles from leaking to the outside. As the film, a film made of PET material is mainly used, and such a film has a lower heat resistance temperature and a large calorific value than the silica insulation sheet. Therefore, if the silica insulation sheet is sealed with the film, the heat blocking performance of the silica insulation sheet is degraded.

Accordingly, there is a need for the development of a silica insulation sheet capable of preventing or minimizing the degradation in heat blocking performance of the silica insulation sheet in a high-temperature environment even when the silica insulation sheet is sealed with a film by further increasing the heat blocking performance of the silica insulation sheet.

### SUMMARY

An object of the present disclosure is to provide a silica insulation composite having minimized degradation in heat blocking performance even when sealed with a film, and an insulation member including the same.

Another object of the present disclosure is to provide a battery module and a battery pack including the insulation member.

However, the technical task to be achieved by the present disclosure is not limited to the aforementioned task, and other tasks that are not mentioned will be clearly understood by those skilled in the art from the following description.

According to an aspect of the present disclosure, there is provided an insulation member which includes a silica insulation composite comprising a substrate and a silica network structure, and a film positioned on both surfaces of the silica insulation composite, wherein when heat of 700° C. is applied to a first surface of the insulation member, a 180° C. heat resistance index (A) represented by Equation 1 below is 50% or greater.

$$180 ° C . heat resistance index ( A ) = [ Time ( in seconds ) for insulation member to reach 180 ° C . ] / [ Time ( in seconds ) for silica insulation composite to reach 180 ° C . ] \times 100 \qquad [ Equation 1 ]$$

In Equation 1 above, the time (seconds) it takes for the insulation member to reach 180° C. means the time (seconds) it takes for the temperature of a second surface of the insulation member to reach 180° C., and the time (seconds) it takes for the silica insulation composite to reach 180° C. means the time (seconds) it takes for the temperature of the second surface of the silica insulation composite to reach 180° C. when heat of 700° C. is applied to a first surface of the silica insulation composite on which the film is not laminated.

The time (seconds) it takes for the temperature of the second surface of the insulation member to reach 180° C. may be 15 seconds or more.

When heat of 700° C. is applied to the first surface of the insulation member, a 350° C. heat resistance index (B) represented by Equation 2 below may be 50% or greater.

$$350 ° C . heat resistance index ( B ) = [ Time ( in second ) for insulation member to reach 350 ° C . ] / [ Time ( in seconds ) for silica insulation composite to reach 350 ° C . ] \times 100 \qquad [ Equation 2 ]$$

In Equation 2 above, the time (seconds) it takes for the insulation member to reach 350° C. means the time (seconds) it takes for the temperature of the second surface of the insulation member to reach 350° C., and the time (seconds) it takes for the silica insulation composite to reach 350° C. means the time (seconds) it takes for the temperature of the second surface of the silica insulation composite to reach 350° C. when heat of 700° C. is applied to the first surface of the silica insulation composite on which the film is not laminated.

The time (seconds) it takes for the temperature of the second surface of the insulation member to reach 350° C. may be 100 seconds or more.

The film may have a calorific value of 1,500 J/g to 3,000 J/g.

The silica insulation composite may have a thickness of 0.5 mm to 10 mm.

The silica particles may include silica, methylsilylated silica, dimethylsilylated silica, trimethylsilylated silica, or a mixture thereof.

The silica network structure in the silica insulation composite may include a particle in which a plurality of silica particles having a particle diameter of greater than 0 nm to 5 nm are aggregated or coupled.

The aggregated or coupled particles may have an average particle diameter of 5 nm to 2,000 nm.

The silica insulation composite may have a density of 0.05 g/cm³ to 0.50 g/cm³.

According to another aspect of the present disclosure, there is provided a battery module including one or more battery cells in an internal space, and the above-described insulation member.

According to yet another aspect of the present disclosure, there is provided a battery pack including the above-described battery module.

### BRIEF DESCRIPTION OF THE DRAWINGS

Aspects of the present disclosure can be understood in more detail from the following description taken in conjunction with the accompanying drawings, in which:

FIG. 1 is a perspective view of an insulation member according to an aspect;

FIG. 2A is a perspective view of an insulation member according to an aspect;

FIGS. 2B and 2C are cross-sectional views of an insulation member according to an aspect;

FIG. 3 is a front view of an insulation member according to an aspect;

FIG. 4 is a perspective view of an insulation member according to an aspect; and

FIGS. 5 and 6 are cross-sectional views of equipment which may be used for a heat transfer evaluation experiment.

### DETAILED DESCRIPTION

Hereinafter, aspects of the present disclosure will be described in more detail to facilitate understanding of the present disclosure. At this time, it will be understood that words or terms used in the specification and claims shall not be interpreted as the meaning defined in commonly used dictionaries, and it will be further understood that the words or terms should be interpreted as having a meaning that is consistent with their meaning in the context of the relevant art and the technical idea of the disclosure, based on the principle that an inventor may properly define the meaning of the words or terms to best explain the disclosure.

According to an aspect of the present disclosure, the present disclosure relates to an insulation member which includes a silica insulation composite comprising a substrate and a silica network structure, and a film positioned on both surfaces of the silica insulation composite.

The silica network structure includes a plurality of silica particles and one or more pores, and refers to a network structure formed by three-dimensionally connecting a plurality of silica particles. This structure forms a plurality of continuous pores between the silica particles, and the pores are connected to each other and distributed throughout a structural body.

The silica particles may include silica, methylsilylated silica, dimethylsilylated silica, trimethylsilylated silica, or a mixture thereof. In addition, the silica particles may include both primary particles having a size of approximately greater than 0 nm to less than or equal to 10 nm, or greater than 0 nm to less than or equal to 5 nm, or having a size of approximately 1 nm, and a secondary particle formed by aggregation of the above-described primary particles. The secondary particles may have an average particle diameter of approximately 5 nm to 2,000 nm, 5 nm to 1,000 nm, 5 nm to 500 nm, 5 nm to 100 nm, or 5 nm to 50 nm, but are not limited thereto. The above-described average particle size may be measured by any method known to those skilled in the art, such as scanning electron microscopy, dynamic light scattering, optical microscopy, or size exclusion, but the method is not limited thereto.

The pores included in the silica network structure may include mesopores, or may include micropores or macropores. Here, the “mesopore” is a pore having a pore diameter in the range of approximately 2 nm to approximately 50 nm, the “macropore” is a pore having a pore diameter in the range of greater than approximately 50 nm, and the “micropore” is a pore having a pore diameter in the range of less than approximately 2 nm. Mesopores of at least 50%, at least 60%, at least 70%, at least 80%, at least 90%, at least 95%, at least 96%, at least 97%, at least 98%, at least 99%, or 100% of the pore volume of the silica network structure may be included. In an aspect, the silica network structure may include mesopores. In an aspect, the silica network structure may include mesopores and micropores. The pore size may be measured by any means known to those skilled in the art, such as a gas adsorption experiment, mercury infiltration, capillary flow porometry, positron annihilation lifetime spectroscopy (PALS), or the like, but is not limited thereto.

The silica network structure is not particularly limited as long as it has the above-described network structure by including silica particles, and may include aerogel.

The “aerogel” includes a plurality of primary aerogel particles having a size of greater than approximately 0 nm to less than or equal to 10 nm, or greater than 0 nm to less than or equal to 5 nm, and a secondary aerogel particle formed by aggregation or combination of the above-described primary aerogel particles, and since a plurality of open pores are formed between the above-described primary aerogel particles and between the secondary aerogel particles to form an aggregate, the aerogel forms a three-dimensional network structure.

The aerogel may be inorganic silica aerogel formed from a silicon alkoxide-based compound or water glass as a precursor. As an example, the aerogel may include silica, methylsilylated silica, dimethylsilylated silica, trimethylsilylated silica, or a mixture thereof. As another example, the aerogel may be that at least a portion of SiO₂ present on the surface of a SiO₂ network structure has a bonding structure of Si—O—SiO₂(CH₃), Si—O—SiO(CH₃)₂, or Si—O—Si(CH₃)₃. A specific process for preparing silica aerogel will be described in detail below.

The substrate may be a fiber substrate including a plurality of fibers. The silica insulation composite has a structure in which at least some of a plurality of silica particles (or aerogel particles) are dispersed, and in some aspects coupled, on the surface of a fiber in the substrate, and at the same time, has a structure in which at least some of the plurality of silica particles (or aerogel particles) are dispersed, and in some aspects positioned, in an empty space between discrete fibers in the substrate.

The “aerogel particles” are particles in the form of individual solid units constituting aerogel, and may include both primary aerogel particles having a size of greater than approximately 0 nm to less than or equal to 10 nm, or greater than 0 nm to 5 nm, or having a size of approximately 1 nm or less, and secondary aerogel particles formed by aggregation of the above-described particles. However, aerogel in a silica insulation composite is mostly in the form of secondary aerogel particles or in the form in which the secondary aerogel particles are aggregated and combined, and there may be trace mixtures of primary aerogel particles that do not form secondary aerogel particles. The secondary aerogel particles may have an average particle diameter of approximately 5 nm to 2,000 nm, 5 nm to 1,000 nm, 5 nm to 500 nm, 5 nm to 100 nm, or 5 nm to 50 nm, but are not limited thereto. In the present disclosure, the above-described average particle size may be measured by any method known to those skilled in the art, such as scanning electron microscopy, dynamic light scattering, optical microscopy, or size exclusion, but the method is not limited thereto.

The aerogel may have a matrix skeletal structure including mesopores, and may include micropores or macropores in addition to the mesopores. The aerogel may include mesopores of at least 50%, at least 60%, at least 70%, at least 80%, at least 90%, at least 95%, at least 96%, at least 97%, at least 98%, at least 99%, or 100% of the pore volume of the skeletal structure. In an aspect, the aerogel may include mesopores. In an aspect, the aerogel may include mesopores and micropores. The pore size may be measured by any means known to those skilled in the art, such as a gas adsorption experiment, mercury infiltration, capillary flow porometry, positron annihilation lifetime spectroscopy (PALS), or the like, but is not limited thereto.

Examples of the substrate may be a discrete fiber, a film, a sheet, a net, a fiber, a porous body, a foam, a non-woven body, or a laminate of two or more layers thereof. In addition, depending on the application thereof, the substrate may have surface roughness formed or patterned on the surface thereof.

The substrate may be polyester, polyolefin terephthalate, poly(ethylene) naphthalate, polycarbonate, regenerated cellulose (e.g., rayon), polyamide (e.g., nylon), cotton, spandex (e.g., Lycra manufactured by DuPont), carbon (e.g., graphite), polyacrylonitrile (PAN), oxidized PAN, non-carbonized heat-treated PAN (such as those made of SGL carbon), a glass fiber-based material (S-glass, 901 glass, 902 glass, 475 glass, E-glass, etc.), a silica-based fiber such as Quartz (e.g., Quartzel manufactured by Saint-Gobain), Q-felt (manufactured by Johns Manville), Saffil (manufactured by Saffil), Durablanket (manufactured by Unifrax) or other silica fibers, Duraback (manufactured by Carborundum), a polyaramid fiber such as Kevlar, Nomex, or Sontera (all manufactured by DuPont), Conex (manufactured by Teijin), a polyolefin such as Tyvek (manufactured by DuPont), Dyneema (manufactured by DSM), Spectra (manufactured by Honeywell), other polypropylene fibers such as Typar or Xavan (both manufactured by DuPont), a fluoropolymer such as PTFE under the trade name Teflon (manufactured by DuPont), Goretex (manufactured by W.L. GORE), a silicon carbide fiber such as Nicalcon (manufactured by COI Ceramics), ceramic paper, a ceramic fiber such as Nextel (manufactured by 3M), an acrylic polymer, a basalt fiber, wool, silk, hemp, leather, a suede fiber, a PBO-xylon fiber (manufactured by Toyobo), a liquid crystal material such as Vectran (manufactured by Hoechst), a Cambrelle fiber (manufactured by DuPont), polyurethane, a wool fiber, boron, aluminum, iron, a stainless steel fiber or other thermoplastic resins such as PEEK, PES, PET, PEK, PPS, or the like, but any fiber may be used without limitation as long as it is a fiber which includes spaces or voids into which a silica three-dimensional structure or an aerogel may be easily inserted, thereby improving insulation performance. As an example, the substrate may include glass fiber, basalt fiber, ceramic fiber, and/or ceramic paper, but is not limited thereto.

The substrate may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the substrate may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

The silica insulation composite may have a rectangular parallelepiped shape in which a substrate and a silica network structure (e.g., aerogel) are mixed from an upper surface to a lower surface thereof, but is not limited thereto.

In addition, at least a portion of the upper surface or lower surface, or the entire surface of the silica insulation composite may have a flat shape. Here, the “flat shape” means that irregularities are not formed by an intentional embossing or coating process. In the present disclosure, by forming the upper and lower surfaces of the silica insulation composite to be flat as described above, it is possible to increase the ease of work in laminating a support member such as a sheet on the surface of the upper and lower surfaces in the future, and increase the adhesion retention rate of the support member. In addition, even if the silica insulation composite itself is directly applied as an insulation member without a support member, frictional force with the surface of a device positioned adjacent thereto may be reduced.

In addition, the silica insulation composite may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the silica insulation composite may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

The silica insulation composite may have a density of 0.05 g/cm³ to 0.50 g/cm³, 0.05 g/cm³ to 0.35 g/cm³, 0.05 g/cm³ to 0.30 g/cm³, 0.10 g/cm³ to 0.35 g/cm³, 0.10 g/cm³ to 0.30 g/cm³, 0.15 g/cm³ to 0.35 g/cm³, or 0.15 g/cm³ to 0.30 g/cm³, but is not limited thereto.

The silica insulation composite may have a thermal conductivity at room temperature (23±2° C.) of 30.0 mW/mK or less, 25.0 mW/mK or less, or 20.0 mW/mK or less, and within the above-described range, there is an effect of securing the insulation of the silica insulation composite to the maximum.

The silica insulation composite may have a thermal conductivity at a high temperature (150° C.) of 35.0 mW/mK or less, 30.0 mW/mK or less, or 25.0 mW/mK or less, and within the above-described range, there is an effect of securing the insulation of the silica insulation composite to the maximum.

The silica insulation composite has a compressive strength of 20 kPa to 80 kPa, 20 kPa to 70 kPa, 30 kPa to 80 kPa, 30 kPa to 70 kPa, 35 kPa to 80 kPa, or 35 kPa to 70 kPa at 10% deformation, and may have excellent mechanical strength. Here, the compressive strength may be measured by preparing a sample according to the ASTM C165 specifications.

The silica insulation composite has a tensile strength of 30 N/cm² to 60 N/cm², 40 N/cm² to 55 N/cm², or 45 N/cm² to 55 N/cm², and may have excellent flexibility. Here, the tensile strength may be measured by preparing a sample according to the ASTM D638 specifications.

The silica insulation composite may have a dielectric breakdown strength at room temperature (23±2° C.) of 3 kV/mm or greater, 4 kV/mm or greater, or 5 kV/mm or greater, and although the upper limit thereof is not particularly limited, but may be about 30 kV/mm or less, 25 kV/mm or less, 20 kV/mm or less, or 15 kV/mm or less. Here, the dielectric breakdown strength may be measured in accordance with the ASTM D149 standard.

The silica insulation composite may have a surface resistance at room temperature (23±2° C.) of 1×10¹⁰ (2/sq or greater, 1×10¹¹ (2/sq or greater, or 1×10¹² (2/sq or greater. In addition, the silica insulation composite may have a volume resistivity of 1×10¹⁰ (2 cm or greater, 1×10¹¹ (2 cm or greater, or 1×10¹² (2·cm or greater. The surface resistance and the volume resistivity were measured by applying a voltage of 1,000 V for 60 seconds to any one surface of both surfaces of the silica insulation composite by using a resistivity meter (Hiresta UX MCP-HT800, Mitsubishi Chemical Analytech).

A film may be positioned on both surfaces of the above-described silica insulation composite. In addition, a film may also be positioned on a side surface in a thickness direction of the silica insulation composite. Therefore, the silica insulation composite may have a structure encapsulated by the film.

The film may include a polyethylene (PE) resin, a polyethylene terephthalate (PET) resin, a polypropylene (PP) resin, or a mixture thereof. As an example, the film may be a PET film, but is not limited thereto.

The thickness of the film is not particularly limited, but may be, for example, 0.1 μm to 100 μm, 1 μm to 100 μm, 10 μm to 100 μm, 1 μm to 50 μm, 10 μm to 50 μm, or 25 μm to 40 μm.

In addition, on a surface facing the silica insulation composite of the both surfaces of the film, a pressure-sensitive adhesive layer or an adhesive layer may be positioned.

The pressure-sensitive adhesive layer or the adhesive layer may include an acrylic adhesive, a polyurethane adhesive, an olefin adhesive, an SBR rubber adhesive, or a silicone adhesive, but is not limited thereto.

The thickness of the pressure-sensitive adhesive layer or the adhesive layer is not particularly limited, but may be, for example, 0.1 μm to 100 μm, 1 μm to 100 μm, 10μ m to 100 μm, 1μ m to 50 μm, 10 μm to 50 μm, or 25μ m to 50μ m.

The film may have a calorific value of 1,000 J/g to 3,500 J/g, 1,100 J/g to 3,000 J/g, 1,500 J/g to 3,000 J/g, 2,000 J/g to 3,000 J/g, or 2,500 J/g to 3,000 J/g, but is not limited thereto.

In addition, the insulation member may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the insulation member may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

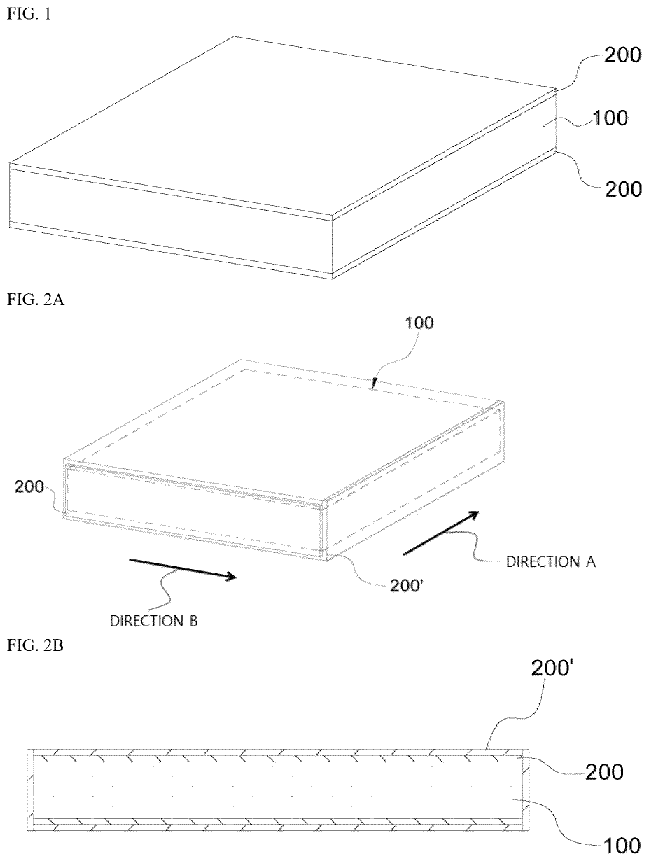

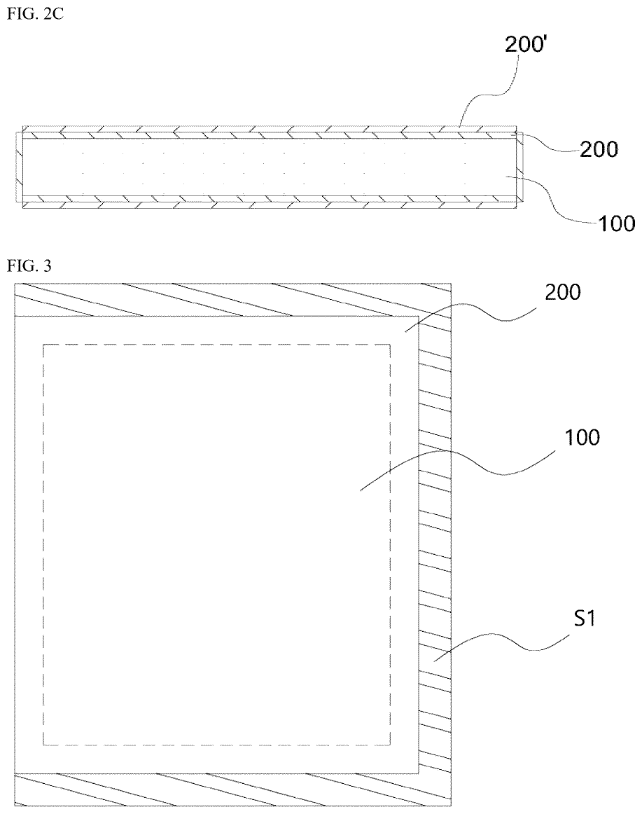

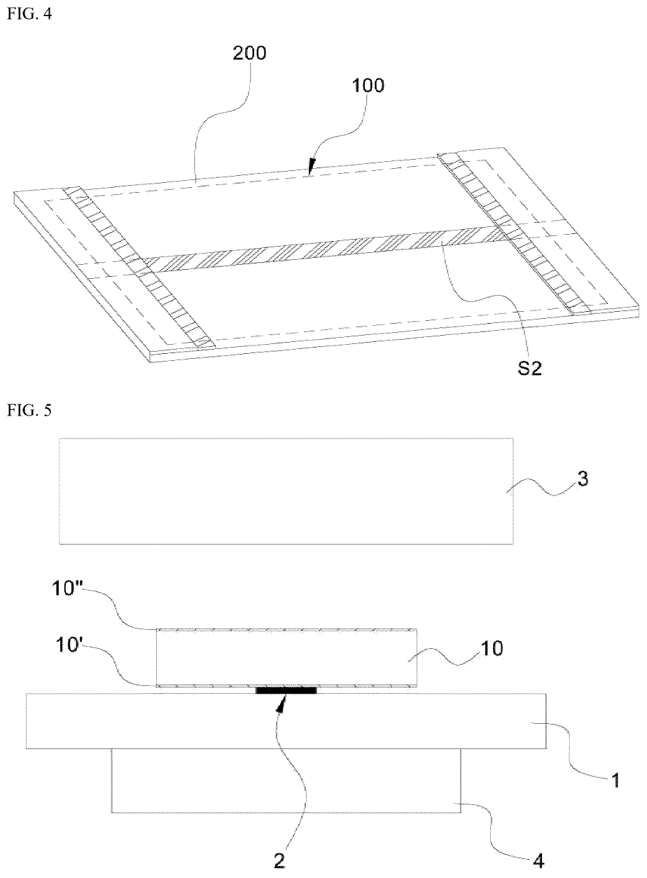

FIG. 1 is a perspective view of an insulation member according to an aspect, and shows a structure in which films 200 cut into a shape corresponding to an upper surface and a lower surface of a silica insulation composite 100 in the shape of a rectangular parallelepiped sheet are laminated. FIG. 2A is a perspective view of an insulation member according to an aspect, and FIGS. 2B and 2C are cross-sectional views of an insulation member in a longitudinal direction and in a width direction respectively. A long-cut film 200 is disposed to wrap the upper surface, a side surface, the lower surface, and the other side surface of the silica insulation composite 100 (dotted line) in the width direction (direction A). Another cut-film 200′ is disposed to wrap the upper surface, the side surface, the lower surface, and the side surface of the silica insulation composite in a longitudinal direction (direction B) perpendicular to the width direction (direction A). Therefore, two layers of the films 200 and 200′ are laminated on the upper surface and the lower surface of the silica insulation composite, but one layer of the film 200 or 200′ is laminated on the side surface of the silica insulation composite. At this time, two ends of one sheet of film may be bonded to each other by contacting each other at a corner (or at arbitrary position) of the silica insulation composite. Although not shown in the drawing, there may be a sealing portion formed by the two ends overlapping each other. FIG. 3 is a front view of an insulation member according to another aspect, and shows a structure in which a silica insulation composite 100 is accommodated inside a folded film 200, and the film is bonded along an outer periphery of the silica insulation composite, thereby forming a sealing portion S1. Although not shown in the drawing, a structure in which a silica insulation composite is interposed between two films, and the two films are in contact along an outer periphery of the silica insulation composite, thereby forming a sealing portion is also included within the scope of the present disclosure. FIG. 4 is a perspective view of an insulation member according to yet another aspect, and shows a structure in which a silica insulation composite 100 is positioned inside a film 200, and the film 200 is folded to wrap all surfaces of the silica insulation composite 100 according to the shape of the silica insulation composite 100, and two ends of the film 200 overlap on one surface of the silica insulation composite 100, thereby forming a sealing portion S2.

When the silica insulation composite such as an aerogel blanket is applied as an insulation member to a battery for an electric vehicle or the like, the silica insulation composite is used in a structure of being wrapped with a film due to problems such as dust generation. However, since a film made of a polymer material such as PET has lower heat resistance and a higher calorific value than the silica insulation composite, when the insulation member is exposed to a high-temperature environment, heat generated from the film may cause pores of the silica insulation composite to collapse or the film may partially melt, thereby blocking or destroying the pores of the silica insulation composite. Accordingly, the heat blocking performance of the silica insulation composite in the insulation member is significantly degraded due to various causes in the high-temperature environment. Therefore, there is a need for the development of a silica insulation composite capable of minimizing the degradation in heat blocking performance in a high-temperature environment even when the silica insulation composite is wrapped with a film.

Even if the silica insulation composite itself has excellent heat resistance, if internal pores are not formed robust, or the strength of a three-dimensional network structure (matrix structure) is low, a film partially melted in a high-temperature environment may easily penetrate into pores of the silica insulation composite, thereby causing the pores to become blocked and collapse. Alternatively, even if the film does not melt, the pores may collapse due to a high calorific value of the film, and eventually, the insulation of the silica insulation composite may be significantly degraded.

As a result of intensive research, the inventors of the present disclosure have developed a silica insulation composite not only having excellent heat resistance but also excellent pore strength, thereby capable of minimizing degradation in heat blocking performance by suppressing the blocking or destroying of pores of the silica insulation composite even when heat is applied to a film wrapping the silica insulation composite. Such an effect may still be expected even if the composition or calorific value of the film changes.

In the present disclosure, the heat resistance of an insulation member was evaluated by applying heat of 700° C. to the first surface of the insulation member, and then measuring the time (seconds) it took for the temperature of the second surface of the insulation member rose to 180° C. or a higher temperature of up to 350° C. Here, the 180° C. is a temperature closely related to the melting point of a typical battery separator, and exceeding this temperature leads to separator damage, which may then lead to thermal runaway, and safety problems. Therefore, assessing the ability of an insulation material for delaying the temperature rise to 180° C. is critically important for enhancing safety. Such a heat resistance index may be used as an index capable of quantitatively comparing heat resistance performance of various insulation designs, and is an important evaluation criterion when selecting a material in a next-generation battery system.

Specifically, in an insulation member including a film wrapping the entire surface of the silica insulation composite, when heat of 700° C. is applied to the first surface of the insulation member, the time (seconds) it takes for the temperature of the second surface of the insulation member to reach 180° C. is characterized by being 50% or greater of the time (seconds) it takes the temperature of the second surface of the silica insulation composite to reach 180° C., when heat of 700° C. is applied to the first surface of the silica insulation composite that is not wrapped with the film (entire surface). Such a characteristic may be represented by Equation 1 below.

$$180 ° C . heat resistance index ( A ) = [ Time ( in seconds ) for insulation member to reach 180 ° C . ] / [ Time ( in seconds ) for silica insulation composite to reach 180 ° C . ] \times 100 \qquad [ Equation 1 ]$$

In Equation 1 above, a 180° C. heat resistance index (A) may be 50% or greater, 55% or greater, 60% or greater, 65% or greater, or 70% or greater.

The time (seconds) it takes for the temperature of the second surface of the insulation member to reach 180° C. may be 15 seconds or more, 15.5 seconds or more, 16 seconds or more, 17 seconds or more, 18 seconds or more, 19 seconds or more, or 20 seconds or more.

In addition, when heat of 700° C. is applied to the first surface of the insulation member of the present disclosure, the time (seconds) it takes for the temperature of the second surface of the insulation member to reach 350° C. is characterized by being 50% or greater of the time (seconds) it takes the temperature of the second surface of the silica insulation composite to reach 350° C., when heat of 700° C. is applied to the second surface of the silica insulation composite that is not wrapped with the film (entire surface). Such a characteristic may be represented by Equation 2 below.

$$350 ° C . heat resistance index ( B ) = [ Time ( in seconds ) for insulation member to reach 350 ° C . ] / [ Time ( in seconds ) for silica insulation composite to reach 350 ° C . ] \times 100 \qquad [ Equation 2 ]$$

In Equation 2 above, a 350° C. heat resistance index (B) may be 50% or greater, 51% or greater, 52% or greater, 54% or greater, 56% or greater, 58% or greater, or 60% or greater.

The time (seconds) it takes for the temperature of the second surface of the insulation member to reach 350° C. may be 100 seconds or more, 105 seconds or more, 110 seconds or more, 115 seconds or more, or 120 seconds or more.

In this specification, the terms “a first surface” and “a second surface” are used to distinguish opposing surfaces of the sheet-shaped silica insulation composite in the thickness direction. For example, a first surface of the insulation member to which heat is applied may be an outer exposed surface of a film laminated on an upper surface of the sheet-shaped silica insulation composite, in which case, a second surface, the temperature of which is measured, may be an outer exposed surface of a film laminated on a lower surface of the sheet-shaped silica insulation composite. Conversely, when the first surface to which heat is applied is an outer exposed surface of a film laminated on a lower surface of the silica insulation composite, the second surface, the temperature of which is measured, may be an outer exposed surface of a film laminated on an upper surface of the silica insulation composite. Thus, the designation of “a first surface” and “a second surface” is not limited to a structural upper-lower relationship, but is merely intended to distinguish the surface to which heat is applied from the opposite surface on which the temperature is measured.

In this specification, the phrase “the time required for the second surface of the insulation member or the silica insulation composite to reach 180° C. or 350° C.” refers to the elapsed time from when heat of 700° C. is applied to the first surface of the insulation member or the silica insulation composite until the temperature of the opposite surface (i.e., the second surface), to which heat is not directly applied, increases from 50° C. to 180° C. or 350° C.

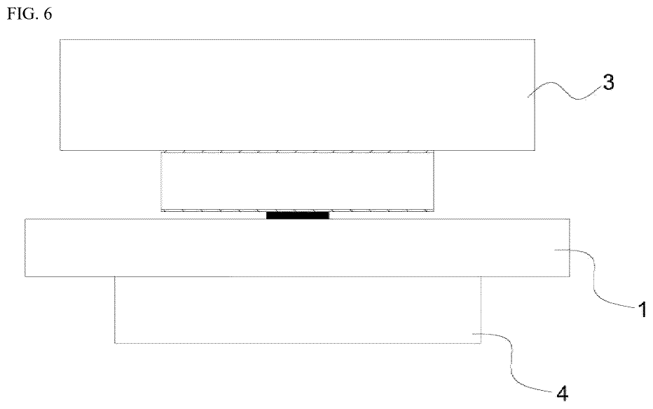

A method for measuring the time (seconds) to reach a temperature of 180° C. or a temperature of 350° C. by applying heat of 700° C. to the insulation member and the silica insulation composite is as follows: First, as equipment for a heat transfer experiment, any equipment which includes a heating device capable of applying heat to the first surface of an insulation member in a rectangular parallelepiped shape, and a thermometer capable of measuring the temperature of the second surface of the insulation member may be used without limitation. FIGS. 5 and 6 schematically depict equipment which may be used in a heat transfer experiment. The equipment may include an insulation board 1 on which a specimen is placed, a temperature sensor 2 positioned on the insulation board 1 and configured to measure the temperature of the first surface 10′ in contact with the insulation board 1 of both surfaces of the specimen 10, a heating plate 3 positioned opposing the insulation board 1 and configured to heat the second surface 10″ different from the contact surface with the insulation board of both surfaces of an upper surface and a lower surface of the specimen, and a pressing part 4 connected to the heating plate 3 and configured to press the insulation board 1 toward the heating plate 3. FIG. 5 illustrates a state in which the second surface 10″ of the specimen is in contact with the heating plate 3 by adjusting the pressing part 4. As an insulation member specimen on which a heat transfer experiment is to be performed, a specimen in a rectangular parallelepiped shape having a size of about 75 mm×75 mm in width×length is prepared. After placing the insulation member specimen on an insulating board, the specimen is left to stand until the temperature of the first surface of the specimen becomes 50° C. or lower (e.g., at room temperature of 25±5° C.), using a temperature sensor positioned between the specimen and the insulating board. The heating plate is heated to 700° C., and the pressing unit is adjusted to apply a pressure of 500 kPa so that the upper surface of the insulation member specimen came into contact with the heating plate. The temperature of the lower surface of the specimen is measured using the temperature sensor positioned between the specimen and the insulating board, and the time (in seconds) required for the lower surface of the specimen to reach 180° C. or 350° C. from the point at which the lower surface reaches 50° C. is measured.

The heat resistance index is a percentage of the time it takes to reach a corresponding temperature in the insulation member to the time it takes to reach the corresponding temperature in the silica insulation composite, and thus, is an index that reflects the heat blocking performance of the silica insulation composite regardless of the thickness of each element constituting the insulation member. However, as an example, the heat resistance index may be based on an insulation member thickness of 0.5 mm to 10 mm, or 1 mm to 5 mm, or 1.5 mm to 3 mm, or 2 mm to 3 mm. As another example, the heat resistance index may be based on a silica insulation composite thickness of 0.5 mm to 10 mm, or 1 mm to 5 mm, or 1.5 mm to 3 mm, or 2 mm to 3 mm, and a thickness of a film to be laminated on a surface of the silica insulation composite of 10 μm to 100 μm, or 10 μm to 50 μm. As yet another example, the heat resistance index may be based on a silica insulation composite thickness of 0.5 mm to 10 mm, or 1 mm to 5 mm, or 1.5 mm to 3 mm, or 2 mm to 3 mm, a thickness of a film to be laminated on a surface of the silica insulation composite of 10 μm to 100 μm, or 10 μm to 50 μm, and a thickness of a pressure-sensitive adhesive layer or adhesive layer to be placed between the surface of the silica insulation composite and the film of 10 μm to 100 μm, or 10 μm to 50 μm.

The insulation member having excellent heat blocking performance provided by the present disclosure may be applied as an insulation material for a battery, but may also be applied as an insulation material, thermal insulation material, or non-combustible material in the fields of construction, aviation, automobiles, home appliances, semiconductors, and industrial facilities.

A method for manufacturing the insulation member of the present disclosure may include preparing a silica insulation composite, and wrapping the silica insulation composite with a film.

The silica insulation composite may be generally formed by preparing a silica sol, impregnating a substrate with the silica sol, and then performing gelation thereon, and drying the same. Hereinafter, each step will be described. However, the specific preparation processes or examples thereof described herein are not intended to be limited to any particular type of an aerogel composite or a preparation method thereof. The present specification may include any aerogel formed by any associated preparation method known to those skilled in the art.

### Preparation of Silica Sol

In the present disclosure, a silica precursor composition may be used to prepare a silica sol.

The silica precursor may be used without limitation as long as it is a precursor which may be used to form a silica three-dimensional structure, e.g., aerogel, and for example, may be a silicon-containing alkoxide-based compound. Specifically, the silica precursor may be tetraalkyl silicate such as tetramethyl orthosilicate (TMOS), tetraethyl orthosilicate (TEOS), methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, or tetradodecyl orthosilicate, and in some aspects is tetraethyl orthosilicate (TEOS), but is not limited thereto.

In addition, the silica precursor may be a water glass solution. Here, the water glass solution may be a diluted solution in which distilled water is added to water glass and then mixed therewith, and the water glass may be sodium silicate (Na₂SiO₃) which is an alkali silicate salt obtained by melting silicon dioxide (SiO₂) and alkali.

In addition, the silica precursor may include a pre-hydrolyzed TEOS (HTEOS). The HTEOS is an ethyl silicate oligomer material having a wide molecular weight distribution, and when synthesized into an oligomer form from a TEOS monomer, physical properties such as gelation time may be adjusted, and thus, may be easily applied according to a user's reaction conditions. In addition, there is an advantage in that reproducible physical properties of a final product may be created. The HTEOS may typically be synthesized by a condensation reaction of TEOS which has undergone a partial hydration step under acidic conditions. That is, the HTEOS is in the form of an oligomer prepared by condensing TEOS, wherein the oligomer is partially hydrated.

The pre-hydrolyzed silica precursor may be prepared by mixing the silica precursor and an organic solvent in a weight ratio of 1:0.1 to 1.5, 1:0.5 to 1.5, or 1:0.5 to 1.2, but is not limited thereto.

In addition, the pre-hydrolyzed silica precursor may be prepared by mixing the silica precursor and water in a molar ratio of 1:0.1 to 10, 1:1 to 8, or 1:2 to 6, but is not limited thereto.

The silica precursor composition may further include silicate including a hydrophobic group. In the present disclosure, the type of the silicate including a hydrophobic group is not limited as long as it is an alkyl silane compound including an alkyl group inducing hydrophobization and a silane functional group capable of reacting with an—Si—O-functional group of a wet gel, but specific examples thereof may include one or more selected from the group consisting of methyltriethoxysilane (MTES), trimethylethoxysilane (TMES), trimethylsilanol (TMS), methyltrimethoxysilane (MTMS), dimethyldiethoxysilane (DMDEOS), ethyltriethoxysilane (ETES), and phenyltriethoxysilane (PTES), but are not limited thereto. For example, the silica precursor composition may further include trimethylethoxysilane (TMES).

When preparing the silica insulation composite, the heat resistance or flame retardancy of the silica insulation composite may be improved by including ammonium bicarbonate (NH₄HCO₃) or ammonium carbonate ((NH₄)₂CO₃) particles on the silica insulation composite or in pores of the silica three-dimensional network structure (e.g., aerogel), for example, in an amount of about 50 ppm to 280 ppm. To this end, when preparing the silica precursor composition, a silicate containing ammonium ions (NH₄⁺) in an amount of 0.1 wt % to 2 wt % may be further added, and for a more specific example, trimethylethoxysilane (TMES) containing ammonium ions (NH₄⁺) in an amount of 0.1 wt % to 2 wt % may be added, but is not limited thereto. Here, trimethylethoxysilane (TMES) containing ammonium ion (NH₄⁺) may be prepared by heating and refluxing hexamethyldisilazane (HMDS) in the presence of an organic solvent and an acid catalyst at a temperature of about 100° C. to 140° C. for 10 minutes to 6 hours, but is not limited thereto.

When the silicate including a hydrophobic group is included in the silica precursor composition, the silicate including a hydrophobic group and the tetraalkyl silicate may be included in a molar ratio (molar ratio of silicate including a hydrophobic group:tetraalkyl silicate) of 9:1 to 1:9. Within the above-described range, the strength and insulation performance of aerogel may be improved.

In addition, the silica concentration of the silica precursor composition may be 10 kg/m³ to 100 kg/m³, 20 kg/m³ to 80 kg/m³, 30 kg/m³ to 70 kg/m³, 30 kg/m³ to 60 kg/m³, or 35 kg/m³ to 45 kg/m³, but is not limited thereto. The silica concentration is the concentration of the silica included in the silica precursor with respect to the silica precursor composition, and may be suitably adjusted by varying the contents of a silica precursor, an organic solvent, and water.

The silica precursor may be used in an amount such that the content of silica contained in the silica sol is to be 0.1 wt % to 30 wt %, but is not limited thereto. If the content of the silica satisfies the above-described range, both the mechanical properties and the insulation of the silica insulation composite may be improved.

The silica sol may include water and/or a polar organic solvent in the silica precursor composition.

When preparing the silica sol, the silica sol may be prepared by mixing the silica precursor composition and water in a molar ratio of 1:0.1 to 20, 1:1 to 10, or 1:2 to 10, but is not limited thereto.

In addition, the polar organic solvent may include an alcohol, and specific examples thereof may include a monohydric alcohol such as methanol, ethanol, isopropanol, or butanol, a polyhydric alcohol such as glycerol, ethylene glycol, propylene glycol, diethylene glycol, dipropylene glycol, or sorbitol, or a combination thereof, but other solvents as known to those skilled in the art may also be used without limitation. In the present disclosure, when considering the miscibility with water and aerogel, the polar organic solvent may be a monohydric alcohol having 1 to 6 carbon atoms such as methanol, ethanol, isopropanol, or butanol, and may be, for example, ethanol.

The polar organic solvent may be used in an appropriate amount by those skilled in the art in consideration of the degree of hydrophobicity in a silica insulation composite to be finally prepared while promoting a surface modification reaction.

When preparing the silica sol, the silica sol may be prepared by mixing the silica precursor composition and an organic solvent in a weight ratio of 1:2 to 10, 1:2 to 8, or 1:2 to 6, but is not limited thereto.

The silica precursor composition may further include an acid catalyst, and specifically, may further include an acid catalyst when applying an alkoxy silane-based compound, which is not a hydrolysate, as a precursor. At this time, the acid catalyst may be used without limitation as long as it is an acid catalyst which allows the pH to be 3 or less, and as an example, a hydrochloric acid, a nitric acid, a sulfuric acid, a phosphoric acid, an oxalic acid, or an acetic acid may be used. At this time, the acid catalyst may be added in an amount which allows the pH of the sol to be 3 or less, and may be added in the form of an aqueous solution in which the acid catalyst is dissolved in an aqueous solvent.

The catalyst composition may include, as a base catalyst, an inorganic base such as sodium hydroxide or potassium hydroxide, or an organic base such as ammonium hydroxide. Specific examples thereof may include sodium hydroxide (NaOH), potassium hydroxide (KOH), calcium hydroxide (Ca(OH)₂), ammonia (NH₃), ammonium hydroxide (NH₄OH; ammonia water), tetramethylammonium hydroxide (TMAH), tetraethylammonium hydroxide (TEAH), tetrapropylammonium hydroxide (TPAH), tetrabutylammonium hydroxide (TBAH), methylamine, ethylamine, isopropylamine, monoisopropylamine, diethylamine, diisopropylamine, dibutylamine, trimethylamine, triethylamine, triisopropylamine, tributylamine, choline, monoethanolamine, diethanolamine, 2-aminoethanol, 2-(ethyl amino) ethanol, 2-(methyl amino) ethanol, N-methyl diethanolamine, dimethylaminoethanol, diethylaminoethanol, nitrilotriethanol, 2-(2-aminoethoxy) ethanol, 1-amino-2-propanol, triethanolamine, monopropanolamine, dibutanolamine, pyridine, a combination thereof, or the like, but are not limited thereto.

The base catalyst may be included in an amount which allows the pH of the sol to be 7 to 11. If the pH of the sol is out of the above range, gelation may not be easily achieved or a gelation rate may be too low, so that processability may be degraded. In addition, since the base may be precipitated when introduced in a solid phase, the base may be added in a solution phase diluted by an aqueous solvent or the above-described organic solvent. At this time, the dilution ratio of the base catalyst and the organic solvent, specifically an alcohol, may be 1:4 to 1:100 based on a volume basis, but is not limited thereto.

In order to prepare the silica sol, the silica precursor composition and the catalyst composition may be mixed in a volume ratio of 1:0.01 to 10.0, 1:0.01 to 5.0, or 1:0.01 to 2.0, but is not limited thereto.

In the present disclosure, heat resistance and flame retardancy of the silica insulation composite may be further improved by adding a mixture of CaMg₃(CO₃)₄ (huntite) and hydromagnesite, a plate-shaped Mg(OH)₂, or a mixture thereof as an additive to the silica sol. The additive may be added in an amount of 0.1 parts by weight to 10 parts by weight, 0.1 parts by weight to 7 parts by weight, 0.5 parts by weight to 7 parts by weight, or 0.5 parts by weight to 5 parts by weight based on the silica content of the silica network structure (particularly, aerogel), but is not limited thereto

In addition, if necessary, an additive may be further added to the silica sol. At this time, all known additives which may be added when preparing aerogel may be applied as the additive, and for example, an additive such as an opacifying agent may be used.

### Gelation of Silica Sol

In the present disclosure, after the silica sol is impregnated into the substrate, the silica sol may be subjected to gelation.

The impregnation process is a process of allowing a catalyzed silica sol to permeate into pores inside the substrate, and may be performed by introducing the catalyzed silica sol and the substrate into a reaction vessel, or may be performed by spraying the catalyzed silica sol on the substrate which is moving on a conveyor belt according to a roll-to-roll process. At this time, in order to improve the bonding between the substrate and the silica sol, the substrate may be lightly pressed down to be sufficiently impregnated. Thereafter, the substrate may be pressed to a predetermined thickness with a predetermined pressure to remove excess silica sol, so that drying time may be reduced.

The temperature of the silica sol in the reaction vessel may be 10° C. to 40° C., 20° C. to 40° C., 25° C. to 40° C., 30° C. to 40° C., or 35° C. to 45° C. When the temperature of the silica sol in the reaction vessel satisfies the above range, the above-described viscosity range of the catalyzed sol may be more easily achieved, and even if the retention time is relatively short, a desired level of viscosity range may be achieved.

The catalyzed silica sol may be impregnated into the substrate in a volume ratio of 0.1 to 10:1 (catalyzed silica sol: substrate), a volume ratio of 0.1 to 1:1, a volume ratio of 0.3 to 1:1, a volume ratio of 0.5 to 1:1, or a volume ratio of 0.7 to 1:1, but is not limited thereto.

The silica sol impregnated into the substrate may be subjected to gelation simultaneously with the impregnation process of the silica sol or sequentially after the impregnation process.

The substrate impregnated with the catalyzed sol may be subjected to gelation on a moving element such as a conveyor belt.

The “gelation” may refer to a sol-gel reaction, and the “sol-gel reaction” may be forming a network structure from a silicon unit precursor material. Here, the network structure may be a planar mesh structure in which specific polygons having one or more types of atomic arrangement are linked to each other, or a structure in which specific polyhedrons share their vertices, edges, faces, and the like with each other to form a three-dimensional skeletal structure.

The gelation may be performed under an ambient atmosphere temperature of 20° C. to 40° C., 25° C. to 35° C., or 30 to 35° C. in terms of increasing the strength of the pore structure.

The gelation time is not particularly limited, but may be, for example, 1 minute to 120 minutes, 1 minute to 100 minutes, 1 minute to 60 minutes, 5 minutes to 60 minutes, 5 minutes to 40 minutes, 10 minutes to 40 minutes, 10 minutes to 30 minutes, or 10 minutes to 20 minutes.

### Aging of Gelled Wet Gel Composite

In the present disclosure, if necessary, an aging step may be further included, which is leaving the wet gel composite obtained by gelation as described above to stand at an appropriate temperature so as to achieve a complete chemical change. In the aging step, the network structure formed by the gelation may be formed more robust, so that the mechanical stability of the silica insulation composite may be improved.

The aging step may be performed by leaving the gelled wet gel composite to stand as it is at an appropriate temperature, or may be performed by adding a cross-linking-promoting compound.

The aging step may be performed by adding a solution in which a base catalyst such as sodium hydroxide (NaOH), potassium hydroxide (KOH), ammonium hydroxide (NH₄OH), triethylamine, pyridine, or the like is diluted to a concentration of 1% to 10% in an organic solvent, in the presence of the wet gel composite. In this case, a Si—O—Si bonding in a silica network structure (e.g., aerogel) is induced to the maximum to allow the network structure of a silica gel to be firmer, so that there is an effect of facilitating the maintenance of the pore structure in a drying process be performed later. At this time, the organic solvent may be the alcohol described above, and specifically, may include ethanol.

In addition, in the aging step, a mixed solution of an alkoxy silane-based compound and an alcohol may be added to provide an additional sol precursor source as well as unreacted sol to induce additional gelation in the silica gel network structure, thereby further strengthening the gel structure. At this time, the alkoxy silane-based compound may be included in an amount of 0.5 parts by weight to 9.5 parts by weight, 1.0 part by weight to 9.5 parts by weight, or 1.5 parts by weight to 9.5 parts by weight based on the total 100 parts of the aging solution.

The alkoxy silane-based compound may include one or more selected from the group consisting of tetramethyl orthosilicate (TMOS), tetraethyl orthosilicate (TEOS), methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, tetradodecyl orthosilicate, methyltrimethoxysilane (MTMS), methyltriethoxysilane (MTES), trimethylethoxysilane (TMES), trimethylsilanol (TMS), trimethylchlorosilane (TMCS), ethyltriethoxysilane (ETES), dimethyldiethoxysilane (DMDEOS), and phenyltriethoxysilane.

In the present disclosure, in order to improve the flame retardancy or heat resistance of the silica insulation composite by including some of ammonium bicarbonate (NH₄HCO₃) or ammonium carbonate ((NH₄)₂CO₃) particles on a finally prepared aerogel composite or in pores of a silica three-dimensional network structure, e.g., aerogel, trimethylethoxysilane (TMES) containing ammonium ions (NH₄⁺) in an amount of 0.1 wt % to 2 wt % as an alkoxy silane-based compound may be added during aging, but the present disclosure is not limited thereto.

In addition, the alcohol may specifically be a monohydric alcohol such as methanol, ethanol, isopropanol, or butanol, or a polyhydric alcohol such as glycerol, ethylene glycol, propylene glycol, diethylene glycol, dipropylene glycol, or sorbitol. For example, the alcohol may be a monohydric alcohol having 1 to 6 carbon atoms such as methanol, ethanol, isopropanol, or butanol, and may be, for example, ethanol, but is not limited thereto.

The aging step may be performed by leaving the gelled wet gel composite to stand at a temperature of 30° C. to 80° C., 40° C. to 80° C., or 50° C. to 80° C. for 0.1 hours to 20 hours, 0.5 hours to 15 hours, 0.5 hours to 10 hours, 0.5 hours to 7 hours, or 1 hour to 5 hours to strengthen the pore structure, and within this range, it is possible to prevent an increase in production costs by preventing a loss of the solvent due to evaporation while preventing a decrease in productivity.

In addition, the aging step may be performed by performing primary aging of leaving the gelled wet gel composite at 30° C. to 80° C. for 0.1 hours to 5 hours to strengthen the pore structure, and then performing secondary aging at 30° C. to 80° C. for 0.1 hours to 20 hours, 0.5 hours to 15 hours, 0.5 hours to 10 hours, 0.5 hours to 7 hours, or 1 hour to 5 hours, by adding a solution in which the above-described basic catalyst is diluted in an organic solvent.

In addition, in order to strengthen the pore structure as well as to hydrophobize the inside of the pores, the aging step may be performed by performing primary aging as described above, and then performing secondary aging at 30° C. to 80° C. for 0.1 hours to 20 hours, 0.5 hours to 15 hours, 0.5 hours to 10 hours, 0.5 hours to 7 hours, or 1 hour to 5 hours by adding a mixed solution of an alkoxy silane-based compound and an alcohol.

The aging step may be performed in a separate reaction vessel after recovering the gelled wet gel composite, or may be performed inside the reaction vessel in which the gelation step has been performed.

### Surface Modification of Aged Wet Gel Composite

The present disclosure includes a surface modification step of hydrophobizing the surface of the wet gel composite obtained by gelation as described above or the surface of the aged wet gel composite in the presence of a surface modifier.

As the surface modifier, a compound which hydrophobizes the surface of a wet gel may be applied without limitation, which may be, for example, a silane-based compound, a siloxane-based compound, a silanol-based compound, a silazane-based compound, or a combination thereof. Specific examples thereof may be a silane-based compound such as trimethylchlorosilane (TMCS), dimethyldimethoxysilane, dimethyldiethoxysilane, methyltrimethoxysilane (MTMS), methyltriethoxysilane (MTES), trimethylethoxysilane (TMES), vinyltrimethoxysilane, ethyltriethoxysilane, phenyltriethoxysilane, phenyltrimethoxysilane, tetraethoxysilane, dimethyldichlorosilane, or 3-aminopropyltriethoxysilane, a siloxane-based compound such as polydimethyl siloxane (PDMS), polydiethyl siloxane, or octamethyl cyclotetra siloxane, a silanol-based compound such as trimethylsilanol, triethylsilanol, triphenyl silanol, or t-butyldimethylsilanol, a silazane-based compound such as 1,2-diethyldisilazane, 1,1,2,2-tetramethyldisilazane, 1,1,3,3-tetramethyldisilazane, 1,1,1,2,2,2-hexamethyldisilazane (HMDS), 1,1,2,2-tetraethyldisilazane, or 1,2-diisopropyldisilazane, or a combination thereof, but are not limited thereto.

In the present disclosure, in order to improve the flame retardancy or heat resistance of the silica insulation composite by including some of ammonium bicarbonate (NH₄HCO₃) or ammonium carbonate ((NH₄)₂CO₃) particles on a finally prepared aerogel composite or in pores of a silica three-dimensional network structure (e.g., aerogel), trimethylethoxysilane (TMES) containing ammonium ions (NH₄⁺) may be used in an amount of 0.1 wt % to 2 wt % as a surface modifier, but the present disclosure is not limited thereto. The surface modifier may be used in a solution phase diluted in an organic solvent. Here, the organic solvent may be an alcohol (an organic solvent), and at this time, the surface modifier may be diluted to 1 vol % to 15 vol %, 1 vol % to 10 vol %, or 1 vol % to 5 vol %, based on the total volume of the diluted solution.

In addition, the surface modifier may be added in an amount of 0.01 vol % to 95 vol %, 0.1 vol % to 90 vol %, 1 vol % to 90 vol %, 10 vol % to 90 vol %, 50 vol % to 90 vol %, or 70 vol % to 90 vol %, with respect to the wet gel composite for a sufficient surface modification effect, but is not limited thereto.

In addition to using a surface modifier containing ammonium ions (NH₄⁺) in the surface modification step, ammonia water may be additionally added to allow ammonium bicarbonate (NH₄HCO₃) or ammonium carbonate ((NH₄)₂CO₃) particles to be included in the above-described content on the finally prepared aerogel composite or in pores of the silica three-dimensional network structure (e.g., aerogel), or to allow ammonia gas to be generated in an amount of the above-described range per unit weight of the silica insulation composite when the silica insulation composite is heated at a temperature of 150° C. for 60 minutes.

The surface modification step may be performed at a temperature of 50° C. to 90° C. or 50° C. to 80° C. for 1 hour to 24 hours, 2 hours to 12 hours, or 4 hours to 24 hours, but is not limited thereto.

### Drying Step

In the present disclosure, a drying step of drying the surface-modified wet gel composite to obtain a silica insulation composite may be included.

The drying is performed as a process of removing only the solvent while maintaining the pore structure of the aged gel, and may be performed, for example, by supercritical drying or normal-pressure drying.

The supercritical drying process is performed using supercritical carbon dioxide, and for example, may be performed by placing the aged wet gel composite in a supercritical drying reactor, filling the reactor with CO₂ in a liquid state, performing a solvent replacement process of replacing an alcohol solvent inside the wet gel with CO₂, followed by raising the temperature to a temperature of 40° C. to 70° C. at a predetermined temperature increase rate, for example, a rate of 0.1° C./min to 1° C./min, and then maintaining a pressure equal to or higher than the pressure at which carbon dioxide becomes supercritical, for example, a pressure of 100 bar to 150 bar, thereby maintaining the supercritical state of carbon dioxide for a predetermined period of time, specifically, 20 minutes to 1 hour. In general, carbon dioxide becomes supercritical at a temperature of 31° C., and a pressure of 73.8 bar. After the predetermined temperature and the predetermined pressure at which carbon dioxide becomes supercritical are maintained for 2 hours to 12 hours, more specifically, 2 hours to 6 hours, the pressure is gradually removed to complete the supercritical drying process, thereby preparing a silica insulation composite, but the present disclosure is not limited thereto.

The pressure of an extract solution discharged from a supercritical extractor used during supercritical drying is lowered to a range of 45 bar to 50 bar, thereby lowering the temperature of the extract solution to a temperature of 30° C. or lower, so that a process of inducing the precipitation of ammonium carbonate or ammonium hydrochloride may not be included.

In addition, the normal-pressure drying process may be performed according to a typical method such as hot air drying or IR drying at a temperature of 70° C. to 200° C. and under a normal pressure (1±0.3 atm), but is not limited thereto.

In the present disclosure, when the silica insulation composite, for example, an aerogel composite, is prepared as described above, a step of wrapping the entire surface of the silica insulation composite with a film, thereby encapsulating the silica insulation composite may be included. An example of the above-described encapsulation process may be performed by cutting a film having a pressure-sensitive layer or an adhesive layer formed on one surface thereof into a shape corresponding to an outer surface of the silica insulation composite, and then adhering the film on the surface of the silica insulation composite, particularly on an upper surface and a lower surface thereof, using the pressure-sensitive layer or the adhesive layer (FIG. 1). As another example, a single film may be prepared, and then all of an upper surface-a side surface-a lower surface-a side surface of the silica insulation composite is wrapped with the film along a width direction (direction A) of the silica insulation composite. In addition, another single film may be prepared, and then all of the upper surface-the side surface-the lower surface-the side surface of the silica insulation composite is wrapped with the film along a longitudinal direction (direction B) of the silica insulation composite. At this time, the film may be cut and prepared in a corresponding shape and size to wrap all of the above-described surfaces (FIGS. 2A, 2B, and 2C). As another example, a single film may be prepared, and the silica insulation composite may be positioned on the film, following by folding the film, and if necessary, the film may be cut into a size to match the size of the silica insulation composite, and then an outer circumferential surface of the film may be thermally fused along an outer periphery of the silica insulation composite or may be sealed by sealing using other methods that use an adhesive or the like (FIG. 3). As another example, two films may be prepared, and the silica insulation composite may be interposed between the two films, and then the films and the silica insulation composite may be fused by thermal fusion, or two layers of films may be sealed by sealing along an outer circumferential surface of the silica insulation composite. As another example, the silica insulation composite is disposed in the center of a cut film, and the film may be folded according to the shape of the silica insulation composite such that the entire surface of the silica insulation composite is completely covered, and edges of the two films overlapping on any one surface of the silica insulation composite may be sealed (FIG. 4).

Another aspect of the present disclosure relates to a battery module or a battery pack including the insulation member according to an aspect of the present disclosure.

The battery module may include a module case having an internal space and one or more battery cells present in the internal space.

The number of battery cells accommodated in the module case is not limited, and may be adjusted according to the use of the battery module. The battery cells accommodated in the module case may be electrically connected to each other. The type of the battery cell accommodated in the module case is not limited, but for example, the battery module may include a cylindrical, prismatic, or pouch-type case battery cell.

The battery module may include the insulation member according to the present disclosure in a module case of the battery module. The insulation member may be positioned between the battery cells accommodated in the module case. The insulation member may be disposed between the module case and the plurality of battery cells, that is, around the module case. A silica insulation composite positioned in the module case may serve as an insulator to reduce heat propagation in the battery module and improve the safety of the battery module.

The battery pack may include one or more of the battery modules. The battery modules may be electrically connected to each other in the battery pack. The battery pack may include the insulation member according to the present disclosure. For example, the insulation member may be positioned between the battery modules of the battery pack. The insulation member may also at least partially surround the plurality of battery modules in the battery pack. The insulation member may act as an insulation material in the battery pack to reduce heat transfer and improve the safety of the battery pack.

The present disclosure may include, but is not limited to, the following aspects of the present disclosure:

1. The present disclosure relates to an insulation member which includes a silica insulation composite comprising a substrate and a silica network structure including a plurality of silica particles and including one or more pores, and a film wrapping the silica insulation composite, wherein when heat of 700° C. is applied to a first surface of the insulation member, a 180° C. heat resistance index (A) represented by Equation 1 below is 50% or greater:

$$180 ° C . heat resistance index ( A ) = [ Time ( in seconds ) for insulation member to reach 180 ° C . ] / [ Time ( in seconds ) for silica insulation composite to reach 180 ° C . ] \times 100 \qquad [ Equation 1 ]$$

In Equation 1 above, the time (seconds) it takes for the insulation member to reach 180° C. means the time (seconds) it takes for the temperature of a second surface of the insulation member to reach 180° C., and the time (seconds) it takes for the silica insulation composite to reach 180° C. means the time (seconds) it takes for the temperature of the second surface of the silica insulation composite to reach 180° C. when heat of 700° C. is applied to a first surface of the silica insulation composite not wrapped with the film.

2. In the first aspect, the time (seconds) it takes for the temperature of the second surface of the insulation member to reach 180° C. may be 15 seconds or more.

3. In at least one of the first and second aspects, when heat of 700° C. is applied to the first surface of the insulation member, a 350° C. heat resistance index (B) represented by Equation 2 below may be 50% or greater:

$$350 ° C . heat resistance index ( B ) = [ Time ( in seconds ) for insulation member to reach 350 ° C . ] / [ Time ( in seconds ) for silica insulation composite to reach 350 ° C . ] \times 100 \qquad [ Equation 2 ]$$

In Equation 2 above, the time (seconds) it takes for the insulation member to reach 350° C. means the time (seconds) it takes for the temperature of the second surface of the insulation member to reach 350° C., and the time (seconds) it takes for the silica insulation composite to reach 350° C. means the time (seconds) it takes for the temperature of the second surface of the silica insulation composite to reach 350° C. when heat of 700° C. is applied to the first surface of the silica insulation composite not wrapped with the film.

4. In at least one of the first to third aspects, the time (seconds) it takes for the temperature of the second surface of the insulation member to reach 350° C. may be 100 seconds or more.

5. In at least one of the first to fourth aspects, the film may have a calorific value of 1,500 J/g to 3,000 J/g.

6. In at least one of the first to fifth aspects, the silica insulation composite may have a thickness of 0.5 mm to 10 mm.

7. In at least of the first to sixth aspects, the silica network structure may include silica, methylsilylated silica, dimethylsilylated silica, trimethylsilylated silica, or a mixture thereof.

8. In at least of the first to seventh aspects, the silica insulation composite may include a particle in which a plurality of silica particles having a particle diameter of greater than 0 nm to 5 nm are aggregated or coupled.

9. In the eighth aspect, the aggregated or coupled particles may have an average particle diameter of 5 nm to 2,000 nm.

10. In at least one of the first to ninth aspects, the silica insulation composite may have a density of 0.05 g/cm³ to 0.50 g/cm³.

11. In at least one of the first to tenth aspects, the silica network structure may include silica aerogel or may be silica aerogel.

12. In at least one of the first to eleventh aspects, the silica insulation composite may be an aerogel composite including a substrate and silica aerogel having a plurality of open pores.

13. The present disclosure relates to a battery module including, in an internal space, one or more battery cells, and at least one insulation member of the first to twelfth aspects.

14. The present disclosure relates to a battery pack including a battery module which includes, in an internal space, one or more battery cells, and at least one insulation member of the first to twelfth aspects.

Hereinafter, the present disclosure will be described in detail with reference to the following examples. However, the following examples are illustrative of the present disclosure, and the contents of the present disclosure are not limited by the following examples.

### Examples

### [Preparation Example 1] Preparation of Silica Insulation Composite

1.30 mol of ethanol and 0.02 g of a HCl acid catalyst were added and mixed, and then 0.62 mol of hexamethyldisilazane (HMDS) was added thereto and mixed. Thereafter, the mixture was subject to reflux at 100° C. for 1 hour, and the generation of ammonia (NH₃) gas was confirmed. Through the above process, trimethylethoxysilane (TMES) containing 0.85 wt % of ammonium ions (NH₄⁺) was prepared. The above-obtained trimethylethoxysilane (TMES) and tetraethyl orthosilicate (TEOS) were mixed in a molar ratio of 1:9 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. The silica sol prepared as described above was added with Mg(OH)₂ in the form of plate-shaped powder in an amount corresponding to 2 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. The aged wet gel composite was added with 90 vol % of a hexamethyldisilazane (HMDS)/ethanol solution (volume ratio of 5:95) as a surface modification solution based on the volume of the wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 2] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. The silica sol prepared as described above was added with Ultracarb (LKAB Co., Ltd.), which is a mixture of CaMg₃(CO₃)₄ (huntite) and hydromagnesite, in an amount corresponding to 0.2 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. In order to prepare a surface modifier, 1.30 mol of ethanol and 0.02 g of a HCl acid catalyst were added and mixed, and then 0.62 mol of hexamethyldisilazane (HMDS) was added thereto and mixed. Thereafter, trimethylethoxysilane (TMES) containing 0.62 wt % of ammonium ions (NH₄⁺) was prepared by reflux at 100° C. for 3 hours. 90 vol % of a solution (10 vol %), which was prepared by diluting the trimethylethoxysilane (TMES) in ethanol, was added based on the volume of the wet gel composite, and then was subjected to surface modification at a temperature of 75° C. for 6 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 3] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. The silica sol prepared as described above was added with Mg(OH)₂ in the form of plate-shaped powder in an amount corresponding to 1.5 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. In order to prepare a surface modifier, 1.30 mol of ethanol and 0.02 g of a HCl acid catalyst were added and mixed, and then 0.62 mol of hexamethyldisilazane (HMDS) was added thereto and mixed. Thereafter, trimethylethoxysilane (TMES) containing 0.51 wt % of ammonium ions (NH₄⁺) was prepared by reflux at 100° C. for 4 hours. 90 vol % of a solution (5 vol %), which was prepared by diluting the trimethylethoxysilane (TMES) in ethanol, was added based on the volume of the wet gel composite, and then ammonia water was added thereto such that 300 ppm of NH₄+ ions were added based on the weight of the trimethylethoxysilane (TMES). The surface modification was then performed at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 4] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. The silica sol prepared as described above was added with Mg(OH)₂ in the form of plate-shaped powder in an amount corresponding to 5 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. As an aging and surface modifier, 1.30 mol of ethanol and 0.02 g of a HCl acid catalyst were mixed, and 0.62 mol of hexamethyldisilazane (HMDS) was mixed therewith, and then refluxed at 100° C. for 1 hour to prepare trimethylethoxysilane (TMES) containing 0.85 wt % of ammonium ions (NH₄⁺). 109 vol % of a solution (2.4 wt %), which was prepared by diluting the trimethylethoxysilane (TMES) in ethanol was added based on the volume of the wet gel composite, and then aged at a temperature of 75° C. for 1 hour. Thereafter, 90 vol % of a solution (10 vol %), which was prepared by diluting the trimethylethoxysilane (TMES) prepared above in ethanol, was added based on the volume of the aged wet gel composite, and then was subjected to surface modification at a temperature of 75° C. for 8 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 5] Preparation of Silica Insulation Composite

1.30 mol of ethanol and 0.02 g of a HCl acid catalyst were mixed, and 0.62 mol of hexamethyldisilazane (HMDS) was mixed therewith, and then refluxed at 100° C. for 3 hours to prepare trimethylethoxysilane (TMES) containing 0.62 wt % of ammonium ions (NH₄⁺). The above-obtained trimethylethoxysilane (TMES) and tetraethyl orthosilicate (TEOS) were mixed in a molar ratio of 1:9 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. The silica sol prepared as described above was added with Ultracarb (LKAB Co., Ltd.), which is a mixture of CaMg₃(CO₃)₄ (huntite) and hydromagnesite, in an amount corresponding to 0.2 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. 109 vol % of a solution (2.4 wt %), which was prepared by diluting the trimethylethoxysilane (TMES) prepared above in ethanol was added based on the volume of the wet gel composite, and then was aged at a temperature of 75° C. for 1 hour. The aged wet gel composite was added with 90 vol % of a hexamethyldisilazane (HMDS)/ethanol solution (volume ratio of 5:95) as a surface modification solution based on the volume of the wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 6] Preparation of Silica Insulation Composite

1.30 mol of ethanol and 0.02 g of a HCl acid catalyst were mixed, and 0.62 mol of hexamethyldisilazane (HMDS) was mixed therewith, and then refluxed at 100° C. for 4 hours to prepare trimethylethoxysilane (TMES) containing 0.51 wt % of ammonium ions (NH₄⁺). The above-obtained trimethylethoxysilane (TMES) and tetraethyl orthosilicate (TEOS) were mixed in a molar ratio of 0.5:9.5 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. The silica sol prepared as described above was added with Ultracarb (LKAB Co., Ltd.), which is a mixture of CaMg₃(CO₃)₄ (huntite) and hydromagnesite, in an amount corresponding to 0.5 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. Thereafter, as a surface modification solution, 90 vol % of a solution (10 vol %), which was prepared by diluting the trimethylethoxysilane (TMES) prepared above in ethanol, was added based on the volume of the aged wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 7] Preparation of Silica Insulation Composite

1.30 mol of ethanol and 0.02 g of a HCl acid catalyst were mixed, and 0.62 mol of hexamethyldisilazane (HMDS) was mixed therewith, and then refluxed at 100° C. for 3 hours to prepare trimethylethoxysilane (TMES) containing 0.62 wt % of ammonium ions (NH₄⁺). The above-obtained trimethylethoxysilane (TMES) and tetraethyl orthosilicate (TEOS) were mixed in a molar ratio of 0.5:9.5 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. The silica sol prepared as described above was added with Mg(OH)₂ in the form of plate-shaped powder in an amount corresponding to 3 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. Thereafter, as a surface modification solution, 90 vol % of a solution (5 vol %), which was prepared by diluting the trimethylethoxysilane (TMES) in ethanol, was added based on the volume of the wet gel composite, and then ammonia water was added thereto such that 500 ppm of NH₄+ ions were added based on the weight of the trimethylethoxysilane (TMES). The surface modification was then performed at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 1] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, the wet gel composite was added with 109% of a solution as an aging solution, which was prepared by diluting 2.4 wt % of ammonium water (NH₄OH) in ethanol with a water content of 10 wt %, based on the volume of the wet gel blanket, and was aged at a temperature of 75° C. for 1 hour. In order to prepare a surface modifier, 1.30 mol of ethanol and 0.02 g of a HCl acid catalyst were added and mixed, and then 0.62 mol of hexamethyldisilazane (HMDS) was added thereto and mixed. Thereafter, trimethylethoxysilane (TMES) containing 0.51 wt % of ammonium ions (NH₄⁺) was prepared by reflux at 100° C. for 4 hours. 90 vol % of a solution (10 vol %), which was prepared by diluting the trimethylethoxysilane (TMES) in ethanol, was added based on the volume of the wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 2] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. The silica sol prepared as described above was added with Mg(OH)₂ in the form of plate-shaped powder in an amount corresponding to 2.5 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, the wet gel composite was added with 109% of a solution as an aging solution, which was prepared by diluting 2.4 wt % of ammonium water (NH₄OH) in ethanol with a water content of 10 wt %, based on the volume of the wet gel blanket, and was aged at a temperature of 75° C. for 1 hour. The aged wet gel composite was added with 90 vol % of a hexamethyldisilazane (HMDS)/ethanol solution (volume ratio of 5:95) as a surface modification solution based on the volume of the wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 3] Preparation of Silica Insulation Composite

Trimethylethoxysilane (TMES) and tetraethyl orthosilicate (TEOS) were mixed in a molar ratio of 1:9 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. The silica sol prepared as described above was added with Ultracarb (LKAB Co., Ltd.), which is a mixture of CaMg₃(CO₃)₄ (huntite) and hydromagnesite, in an amount corresponding to 0.2 parts by weight of the silica concentration. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. The gelled wet gel composite was added with 90 vol % of a hexamethyldisilazane (HMDS)/ethanol solution (volume ratio of 5:95) as a surface modification solution based on the volume of the wet gel composite, and then was subjected to surface modification at a temperature of 75° C. for 4 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 4] Preparation of Silica Insulation Composite

Tetraethyl orthosilicate (TEOS) and water were mixed in a molar ratio of 1:4 and ethanol having a weight ratio of 1:1 with respect to the TEOS was added thereto to prepare a silica precursor solution. In order to promote hydrolysis of the silica precursor solution, an acid was added such that the pH of the silica precursor solution was to be 3 or less and then stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, the wet gel composite was added with a solution as an aging solution, which was prepared by diluting 2.9 wt % of methyltriethoxysilane (MTES) in ethanol with a water content of 10 wt %, and then was aged in an oven at 75° C. for 1 hour. As a surface modification solution, 90 vol % of a solution (10 vol %), which was prepared by diluting trimethylethoxysilane (TMES) in ethanol, was added based on the volume of the aged wet gel composite, and then was subjected to surface modification at a temperature of 75° C. for 12 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 5] Preparation of Silica Insulation Composite

1.30 mol of ethanol and 0.02 g of a HCl acid catalyst were mixed, and 0.62 mol of hexamethyldisilazane (HMDS) was mixed therewith, and then refluxed at 100° C. for 6 hours to prepare trimethylethoxysilane (TMES) containing 0.48 wt % of ammonium ions (NH₄⁺). The above-obtained trimethylethoxysilane (TMES) and tetraethyl orthosilicate (TEOS) were mixed in a molar ratio of 1:9 to prepare a silica precursor composition. The silica precursor composition and water were mixed in a molar ratio of 1:10, and ethanol having a weight ratio of 1:2 with respect to the silica precursor composition was added thereto to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, stabilization was performed at room temperature (25° C.) for 10 minutes, and then aging was performed in an oven at 70° C. for 30 minutes. Thereafter, 90 vol % of a solution (10 vol %), which was prepared by diluting the trimethylethoxysilane (TMES) not containing ammonium ions (NH₄⁺) in ethanol, was added based on the volume of the aged wet gel composite, and then was subjected to surface modification at a temperature of 75° C. for 2 hours. The silica wet gel composite was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Examples 1 to 7 and Comparative Examples 1 to 5] Preparation of Insulation Member

A specimen of each of the silica insulation composites prepared in Preparation Examples 1 to 7 and Comparative Preparation Examples 1 to 5 was prepared to have dimensions of approximately 75 mm×75 mm in width×length. As a film to wrap the silica insulation composite, a PET film (adhesive thickness: about 50 μm, total film calorific value: about 2498 J/g) having a thickness of about 25 μm coated with an acrylic adhesive one surface thereof was prepared. The silica insulation composite was placed in the center of the PET film, and then sealed in a manner that the entire surface of the silica insulation composite was wrapped as shown in FIG. 4 to prepare an insulation member having a thickness of about 2 mm to 2.5 mm.

### [Experimental Example 1: Evaluation of Heat Blocking Efficiency (1)

### 1. Evaluation of 180° C. Reaching Time and Heat Resistance Index (A) of Insulation Member

The evaluation of the heat transfer efficiency of the insulation members prepared as described above was performed using equipment having the structure shown in FIGS. 5 and 6. After placing the insulation member specimens of each of the Examples and Comparative Examples on an insulating board, the specimens were left to stand until the temperature of one surface of each specimen, measured by a temperature sensor positioned between the specimen and the insulating board, reached 25±5° C. The heating plate was heated to 700° C., and the pressing part was adjusted to apply a pressure of 500 kPa so that the upper surface of the insulation member specimen came into contact with the heating plate. The temperature of the lower surface of the specimen was measured using the temperature sensor positioned between the specimen and the insulating board, and the time (in seconds) required for the temperature of the lower surface of the sheet-shaped specimen to reach 180° C. from the point in time at which the temperature of the lower surface reached 50° C. was measured. In addition, an experiment was performed in the same manner for silica insulation composite specimens having a width and length of approximately 75 mm×75 mm, which were prepared in the same manner as in Preparation Examples 1 to 7 and Comparative Preparation Examples 1 to 5, and the time (in seconds) required for the temperature of the lower surface of the specimen to reach 180° C. or 350° C. was measured. For each example, the 180° C. heat resistance index (A) of Equation 1 below was calculated, that is, the percentage obtained by dividing the time required for the temperature of the lower surface of the insulation member to reach 180° C. by the time required for the temperature of the lower surface of the silica insulation composite to reach 180° C., and the results are shown in Table 1 below.

$$180 ° C . heat resistance index ( A ) = [ Time ( in seconds ) for insulation member to reach 180 ° C . ] / [ Time ( in seconds ) for silica insulation composite to reach 180 ° C . ] \times 100 \qquad [ Equation 1 ]$$

TABLE 1

| | Time to reach 180° C. | | |
|---|---|---|---|
| | (seconds) | | |
| | Silica | | |
| | insulation | Insulation | Heat resistance index |
| Classification | composite | member | at 180° C. (A)(%) |
| Example 1 | 29.8 | 16.6 | 55.70 |
| Example 2 | 30.8 | 18.2 | 59.09 |
| Example 3 | 33.2 | 21.8 | 65.66 |
| Example 4 | 29.2 | 21.6 | 73.97 |
| Example 5 | 27.4 | 21.3 | 77.74 |
| Example 6 | 32.1 | 26.5 | 82.55 |
| Example 7 | 28.6 | 24 | 83.92 |
| Example 8 | 460.6 | 442.9 | 96.16 |
| Comparative | 31.2 | 13.2 | 42.31 |
| Example 1 | | | |
| Comparative | 29.2 | 12.1 | 41.44 |
| Example 2 | | | |
| Comparative | 32.6 | 13 | 39.88 |
| Example 3 | | | |
| Comparative | 28.8 | 11.7 | 40.63 |
| Example 4 | | | |
| Comparative | 34.4 | 13.2 | 38.37 |
| Example 5 | | | |

As shown in Table 1 above, in the case of the insulation member including each of the silica insulation composites of Comparative Preparation Examples 1 to 7, it can be seen that the time to reach the temperature of 180° C. was rapidly shortened compared to the silica insulation composite in which a film is not laminated. However, it can be seen that the insulation member including each of the silica insulation composites of Preparation Examples 1 to 7 takes 16 seconds to reach 180° C. even when wrapped with a PET film, and has a smaller degree of decrease in time to reach the temperature of 180° C. than the silica insulation composite in which a film is not laminated.

### 2. Evaluation of 350° C. Reaching Time and Heat Resistance Index (B) of Insulation Member

An experiment was performed in the same manner as in the experiment of 1. above, except that the time (seconds) it took for the lower surface of the insulation member and the lower surface of the silica insulation composite to reach a temperature of 350° C. was measured, and a 350° C. heat resistance index (B) was calculated according to Equation 2, and the results are shown in Table 2 below.

$$350 ° C . heat resistance index ( B ) = [ Time ( in seconds ) for insulation member to reach 350 ° C . ] / [ Time ( in seconds ) for silica insulation composite to reach 350 ° C . ] \times 100 \qquad [ Equation 2 ]$$

TABLE 2

| | Time to reach 350° C. | | |
|---|---|---|---|
| | (seconds) | | |
| | Silica | | |
| | insulation | Insulation | Heat resistance index |
| Classification | composite | member | at 350° C. (B)(%) |
| Example 1 | 209.2 | 109 | 52.10 |
| Example 2 | 213 | 115.2 | 54.08 |
| Example 3 | 207.8 | 121.5 | 58.47 |
| Example 4 | 197.6 | 113.1 | 57.24 |
| Example 5 | 189.4 | 118.2 | 62.41 |
| Example 6 | 215.6 | 133.8 | 62.06 |
| Example 7 | 208 | 135 | 63.38 |
| Example 8 | Not | Not | Not |
| | measurable | measurable | measurable |
| Comparative | 205.6 | 77.9 | 37.89 |
| Example 1 | | | |
| Comparative | 186.3 | 78.2 | 41.98 |
| Example 2 | | | |
| Comparative | 208 | 90.1 | 43.32 |
| Example 3 | | | |
| Comparative | 178.4 | 68.9 | 38.62 |
| Example 4 | | | |
| Comparative | 223.8 | 96.2 | 42.98 |
| Example 5 | | | |

As shown in Table 2 above, in the case of the insulation member including each of the silica insulation composites of Comparative Preparation Examples 1 to 7, it can be seen that the time to reach the temperature of 350° C. was rapidly shortened compared to the silica insulation composite in which a film is not laminated. However, it can be seen that the insulation member including each of the silica insulation composites of Preparation Examples 1 to 7 takes 100 seconds to reach 350° C., and has a much smaller degree of decrease in time to reach the temperature of 350° C. than the silica insulation composite in which a film is not laminated.

From the above experiments, it can be seen that the silica insulation composite according to the present disclosure has excellent heat resistance as well as pore strength, so that even when the silica insulation composite is wrapped with a film, the degradation in heat blocking performance of the silica insulation composite due to the film is minimized.

### [Experimental Example 2: Evaluation of Heat Transfer Efficiency (2)

In order to confirm that the silica insulation composite according to the present disclosure has excellent heat resistance, and thus, even when sealed with any film, the degradation in heat transfer efficiency is suppressed, a specimen of the silica insulation composite of Preparation Example 1 having a size of approximately 75 mm×75 mm was encapsulated with films shown in Table 3 below. In the same manner as in Experimental Example 1, the time (second) for the insulation member to reach 180° C. and 350° C., and the heat resistance index (A and B) were calculated, and the results are shown in Tables 4 and 5 below.

TABLE 3

| | PET film thickness (μm) | Caloric value (J/g) |
|---|---|---|
| Film #1 | PET film of about 25 μm (applied with | 1854 |
| | acrylic adhesive of about 35 μm) | |
| Film #2 | PET film of about 40 μm (applied with | 2913 |
| | acrylic adhesive of about 40 μm) | |

TABLE 4

| | Time to reach 180° C. (seconds) | | |
|---|---|---|---|
| | Silica insulation | Insulation | Heat resistance index |
| Classification | composite | member | at 180° C. (A)(%) |
| Example 8 | 29.8 | 17.3 | 58.05 |
| (Film #1) | | | |
| Example 9 | 29.8 | 15.9 | 53.36 |
| (Film #2) | | | |

TABLE 5

| | Time to reach 350° C. (seconds) | | |
|---|---|---|---|
| | Silica insulation | Insulation | Heat resistance index |
| Classification | composite | member | at 350° C. (B)(%) |
| Example 8 | 209.2 | 113 | 54.02 |
| (Film #1) | | | |
| Example 9 | 209.2 | 106.8 | 51.05 |
| (Film #2) | | | |

As shown in Tables 4 and 5 above, it has been be confirmed that the silica insulation composite according to the present disclosure has excellent heat resistance and pore strength, and thus, still has excellent heat blocking performance even when sealed with PET films having different thicknesses or calorific values. Particularly, it has been confirmed that the silica insulation composite still maintains high heat blocking efficiency even when sealed with a film having a calorific value close to 3000 J/g.

### [Experimental Example 3] Evaluation of Insulation

In order to evaluate the thermal conductivity of the silica insulation composite prepared according to the present disclosure, a silica insulation composite having a size of 100 mm×100 mm in width×length 100 mm was prepared by the method of each of Preparation Example 1 to 7, and the thermal conductivity at room temperature (25±5° C.) was measured using HFM436 equipment manufactured by Netzsch Co., Ltd., and the results are shown in Table 6 below.

TABLE 6

| Classification | Thermal conductivity (mW/mK) |
|---|---|
| Preparation Example 1 | 20.20 |
| Preparation Example 2 | 21.35 |
| Preparation Example 3 | 22.64 |
| Preparation Example 4 | 22.18 |
| Preparation Example 5 | 20.28 |
| Preparation Example 6 | 21.40 |
| Preparation Example 7 | 19.47 |

As shown in Table 6 above, all the silica insulation composites (Preparation Examples 1 to 7) according to the present disclosure have low thermal conductivity and excellent insulation. Although not shown in the above table, the thermal conductivity increases only by about 1 mW/mK to 2 mW/mK even when the entire surface of the silica insulation composite is wrapped with a film in the same manner as in Examples described above, so that it can be confirmed that the silica insulation composite still has excellent insulation performance.

In general, when a PET film with a low heat resistance temperature and a large caloric value is laminated on a silica insulation composite, there is a problem in that the heat blocking performance of the silica insulation composite is significantly degraded in a high-temperature environment. However, a silica insulation composite provided by the present disclosure may maintain a high level of insulation performance in a high-temperature environment even when a film is laminated on an outer surface of the silica insulation composite.

Although the present disclosure has been described with reference to limited examples, the present disclosure is not limited thereto, and it is to be understood by those skilled in the art that various changes and modifications made be made within the equivalent scope of the technical idea of the present disclosure and the claims set forth below.

### DESCRIPTION OF THE REFERENCE NUMERALS OR SYMBOLS

1: Insulation board
2: Temperature sensor
3: Heating plate
4: Pressurizing part
10: Specimen
10′: Insulation board contact surface of both surfaces of specimen
10″: Heating plate contact surface of both surfaces of specimen
100: Silica insulation composite
200, 200′: Film
S1, S2: Sealing portion

What is claimed is:

1. An insulation member comprising:
a silica insulation composite comprising a substrate and a silica network structure, the silica network structure including a plurality of silica particles and one or more pores, and
a film wrapping the silica insulation composite,
wherein when a heat of 700° C. is applied to a first surface of the insulation member, a 180° C. heat resistance index (A) represented by Equation 1 is 50% or greater:
$$180 ° C . heat resistance index ( A ) = [ Time ( in seconds ) for insulation member to reach 180 ° C . ] / [ Time ( in seconds ) for the silica insulation composite to reach 180 ° C . ] \times 100 \qquad [ Equation 1 ]$$
wherein in Equation 1, the time (in seconds) for the insulation member to reach 180° C. is the time (in seconds) it takes for a temperature of a second surface of the insulation member to reach 180° C., and the time (in seconds) for the silica insulation composite to reach 180° C. is the time (in seconds) it takes for a temperature of a second surface of the silica insulation composite to reach 180° C. when a heat of 700° C. is applied to a first surface of the silica insulation composite that is not wrapped with the film.

2. The insulation member of claim 1, wherein the time (in seconds) for the insulation member to reach 180° C. is 15 seconds or more.

3. The insulation member of claim 1, wherein when the heat of 700° C. is applied to the first surface of the insulation member, a 350° C. heat resistance index (B) represented by Equation 2 is 50% or greater:
$$350 ° C . heat resistance index ( B ) = [ Time ( in seconds ) for insulation member to reach 350 ° C . ] / [ Time ( in seconds ) for the silica insulation composite to reach 350 ° C . ] \times 100 \qquad [ Equation 2 ]$$
wherein in Equation 2, the time (in seconds) for the insulation member to reach 350° C. is the time (in seconds) it takes for the temperature of the second surface of the insulation member to reach 350° C., and the time (in seconds) for the silica insulation composite to reach 350° C. is the time (in seconds) it takes for the temperature of the second surface of the silica insulation composite to reach 350° C. when the heat of 700° C. is applied to the first surface of the silica insulation composite that is not wrapped with the film.

4. The insulation member of claim 3, wherein the time (in seconds) for the insulation member to reach 350° C. is 100 seconds or more.

5. The insulation member of claim 1, wherein the film has a calorific value from 1,500 J/g to 3,000 J/g.

6. The insulation member of claim 1, wherein the silica insulation composite has a thickness from 0.5 mm to 10 mm.

7. The insulation member of claim 1, wherein the silica network structure comprises silica, methylsilylated silica, dimethylsilylated silica, trimethylsilylated silica, or a mixture thereof.

8. The insulation member of claim 1, wherein the silica insulation composite comprises a plurality of aggregated particles, in which a plurality of silica particles having a particle diameter from greater than 0 nm to 5 nm are aggregated in each of the plurality of aggregated particles.

9. The insulation member of claim 8, wherein the plurality of aggregated particles have an average particle diameter from 5 nm to 2,000 nm.

10. The insulation member of claim 1, wherein the silica insulation composite has a density from 0.05 g/cm³ to 0.50 g/cm³.

11. A battery module comprising:
one or more battery cells in an internal space of the battery module; and
the insulation member of claim 1.

12. A battery pack comprising the battery module of claim 11.
